(19) United States
(12) Patent Application Publication
(10) Pub. No.: US 2016/0162649 A1
(43) Pub. Date: Jun. 9, 2016

(54) Regression Modeling System Using Activation Scale Values as Inputs to a Regression to Predict Healthcare Utilization and Cost and/or Changes Thereto

(71) Applicant: Insignia Health, LLC, Portland, OR (US)

(72) Inventors: Eldon R. Mahoney, Bellingham, WA (US); Christopher Delaney, Portland, OR (US)

(21) Appl. No.: 15/042,921

(22) Filed: Feb. 12, 2016

Related U.S. Application Data
(63) Continuation-in-part of application No. 14/704,860, filed on May 5, 2015.
(60) Provisional application No. 61/988,583, filed on May 5, 2014.

(51) Int. Cl. G06F 19/00

(52) U.S. Cl. CPC G06F 19/327; G06F 19/363

(57) ABSTRACT

In a regression modeling system, activation scale values over a plurality of survey participants is used to generate a regression to identify a predictive model that can have a direct explanatory relationship to healthcare utilization and cost. The survey can comprise a number of declarative statements and the responses can be an indication of a participant's level of agreement. The activation scale value for a given individual is thus a predictive dependent variable that can be changed with a known effect on outcomes (independent variables). For example, healthcare utilization and costs will decline as an activation scale value goes up.

### CROSS-REFERENCES TO PRIORITY AND RELATED APPLICATIONS

This application is a continuation-in-part of U.S. application Ser. No. 14/704,860, filed May 5, 2015, which claims priority from and is a non-provisional of U.S. Provisional Patent Application No. 61/988,583, filed May 5, 2014 entitled “Regression Modeling System Using Activation Rating Values as Inputs to a Regression to Predict Healthcare Utilization and Cost and/or Changes Thereto.” The entire disclosure of the application recited above is hereby incorporated by reference, as if set forth in full in this document, for all purposes.

### FIELD OF THE INVENTION

The present invention relates generally to modeling systems that can model future patient outcomes and future utilization of healthcare resources.

### BACKGROUND

Using a computer to perform modeling calculations, one can generate a new dataset from existing data. For example, predictions of future costs and healthcare utilization might be modeled through past cost and healthcare utilization metrics, or by long health risk assessment questionnaires.

It was known to use data about past patient behavior (emergency room (“ER”) visits, past hospital admits, past costs incurred) to predict future utilization and cost. Some estimates suggest an R2 range of 0.2 to 0.25, i.e., that these tools identify 20% to 25% of patients that incur high utilization of expensive services in the future. Such models are largely retrospective in nature, and fail to incorporate any evaluation of a person's prospective ability to manage their health and healthcare. These models use observed past utilization behavior and clinical outcomes to attempt to predict future utilization and cost.

It was also known to predict risk through health survey assessments. Survey-based risk measures are typically based upon a compilation of individual variables (demographics, health status questions, lifestyle behavior questions, etc.), many of which are unrelated to one another. There need not be a connection made on any underlying explanatory dimension.

### SUMMARY

In a regression modeling system, activation scale values over a plurality of survey participants is used to generate a regression to identify a predictive model that can have a direct explanatory relationship to healthcare utilization and cost. The survey can comprise a number of declarative statements and the responses can be an indication of a participant's level of agreement. The activation scale value for a given individual is thus a predictive variable that can be changed with a known effect on outcomes. For example, healthcare utilization and costs might decline as an activation scale value goes up. The activation scale corresponds to patient activation and/or patient self-management.

In other aspects, users are provided with a set of declarative statements and asked to respond with their level of agreement or disagreement with each declarative statement, using a scale of agreement, with the levels represented by ordinal values, then converting those ordinal values to a numerical scale that is representable by equal-interval scale continuous variables.

In some aspects, the assessment of self-management (activation) yields an empirically derived equal-interval scale continuous variable that, as a dependent variable in an equation, can predict and quantify outcomes of equal-interval scale continuous outcome variables (the independent variable(s) in the equation). Those independent variable(s) might be predictive of health outcomes that are also equal-interval scale continuous variables such as health care cost and utilization. This also allows for identifying and/or predicting the value of a single point change in activation.

The following detailed description will provide a better understanding of the nature and advantages of the present invention.

### BRIEF DESCRIPTION OF THE DRAWINGS

Various embodiments in accordance with the present disclosure will be described with reference to the drawings, in which:

FIG. 1 is an illustrative example of a block diagram of levels in accordance with at least one embodiment;

FIG. 2 is an illustrative example of a block diagram of a series of declarative statements of a healthcare survey in which various embodiments can be implemented;

FIG. 3 is an illustrative example of a block diagram showing independent and dependent variables in accordance with at least one embodiment;

FIG. 4 is an illustrative example of a process for a predictive healthcare method in accordance with at least one embodiment;

FIG. 5 is an illustrative example of a block diagram showing activation measurement score variables in accordance with at least one embodiment; and

FIG. 6 illustrates an environment in which various embodiments can be implemented.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Methods and computer-implemented systems for assessment are described and suggested herein. Such methods and systems may use a computer for data processing, as explained herein. This computation might be used for risk assessment, planning, cost allocation (such as by health care budgeting, setting health coverage premiums, etc.), as well as for quantifying values and/or efficacy of changes in patient self-management. In particular, the assessment system might be used to identify the risk of future high cost utilization in a population, to quantify the impact of activation scale value change on utilization and cost (how much of, or which type of intervention is needed to drive a known amount in utilization and cost decrease, etc.), and/or to allocate resources efficiently.

Regression analysis is not generally applied to practical survey applications to develop an explanatory model because: Variables that have a direct impact on healthcare utilization and cost that are: (a) capable of being changed and (b) measured as an equal-interval scale continuous variable, do not exist in survey form since the latter must be empirically and mathematically demonstrated.

In embodiments explained herein, the Patient Activation Measure® (PAM®) survey might be used in combination with regression analysis to arrive at an activation scale, wherein values are measured on an equal interval scale and the activation scale is a continuous variable, as with other equal interval scales of continuous variables such as a thermometer or ruler. For example, PAM® survey may be an activation measurement survey or activation score that is used with regression analysis and Rasch measurement modeling to create a standard, empirical measurement technique for determining a predictive model.

Organizations using the PAM® survey tool span the health sector and include health plans, disease management and wellness firms, Medicaid agencies, hospitals and clinics, leading research organizations and pharmaceutical firms. The PAM® survey assessment is reliable and valid for use with both patients managing a chronic condition and with individuals engaged in disease prevention efforts and is being used today broadly in healthcare, including in disease and case management, wellness programs, medical home projects, accountable care organizations, and care transitions.

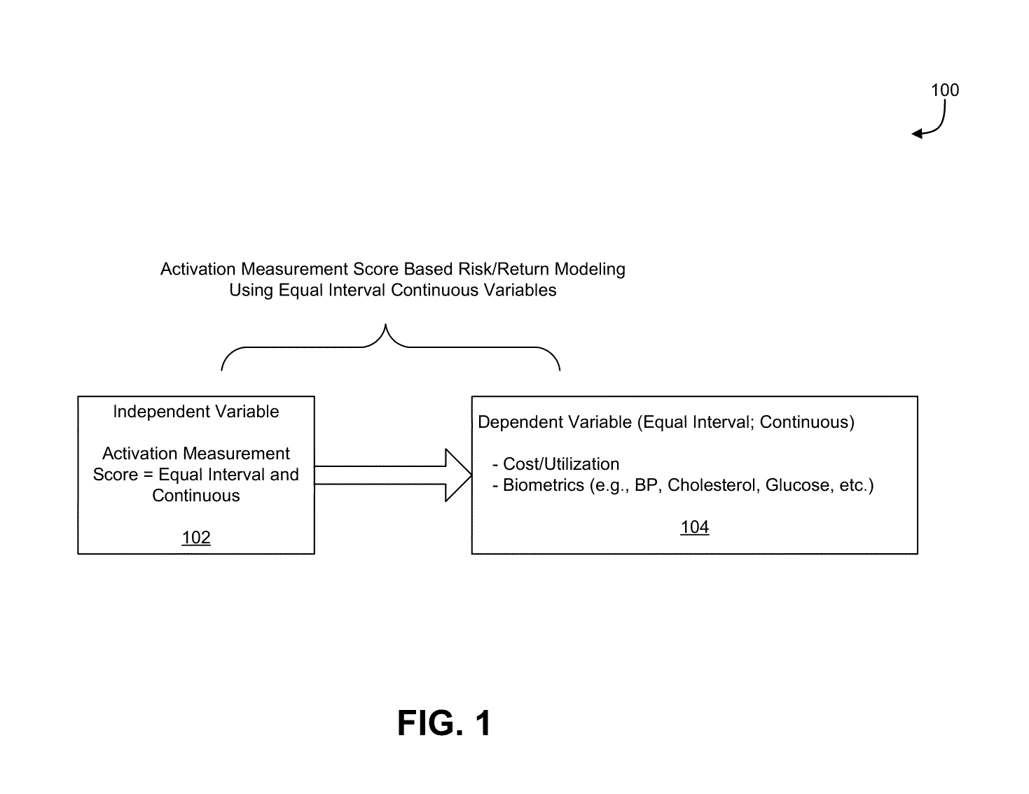

FIG. 1 is an example embodiment of a block diagram 100 for implementing aspects in accordance with various embodiments. A person's activation or self-management ability can be reliably assessed, as shown in peer reviewed published research, in order to understand the risk of future high cost utilization in a population, quantify the impact of activation change on utilization and cost (how much of, or which type of intervention is needed to drive a known amount in utilization and cost decrease), and allocate resources accordingly. Other possible dependent variables might be biometric variables, such as blood pressure, cholesterol levels, blood glucose levels, etc.

Many standard statistical analyses can be of considerable value when applied in a practical context. One such example is ordinary least squares regression (regression). One of the important things regression analyses can tell the user is how much a dependent variable changes (increases or decreases) for every unit of increase in the independent variable. The usefulness of this kind of information is broad. In this context, an example would be: For every one-point increase in a person's measured ability to manage their health (a person's level of activation), what happens to their annual medical costs?

If the concern is reducing the cost of health care, you first need independent variables (variables that impact cost or utilization) that can actually be changed. The second thing you need is the right kind of data. Regression requires that both the independent and dependent variable be equal-interval scale continuous variables. While cost in dollars or units of ER or hospital use are certainly such variables, you must also have an independent variable that is equal interval and continuous.

The independent variable, the activation scale value, and dependent healthcare outcome variables (e.g., number/complexity of ER visits, hospital admits, costs, etc.) can be treated as being continuous and of equal interval, so regression can be done on those variables. The independent variable 102 can be an activation scale that is an equal interval and continuous variable such as a ruler or thermometer, and the dependent variable 104 can be a cost/utilization (resources) variable that is also equal interval and continuous.

An output of a regression analysis system using both independent and dependent continuous variables might be used for the examination of how much healthcare costs and utilization increase or decrease with an increase/decrease in the activation scale value, such as a measure of increases/decreases for a one-point change in a PAM® survey score, as one example of a system that measures self-management in one's health. This can then be used to predict cost savings and utilization changes, assist with decisions such as how to best allocate resources, given the presence of risk, how predicted costs savings compare to the cost of an intervention, the value of a single unit of change along an equal interval scale, and the like.

In particular, one aspect of the calculations performed involves identifying variables, separating independent variables and dependent variables, and using the independent variables' values in a computer model to determine relationships between independent variables and dependent variables. For example, suppose a goal is to reduce the cost of health care over a population. The independent variables that have an impact on the outcomes and that are truly independent are inputs to the model; dependent variables' values are attenuated, isolated, removed, etc. Dependent variables, if the model is built correctly, can be predicted by the independent variable.

If the possible values for an independent variable do not form an equal-interval scale continuous variable, then the independent variable is first converted to such a variable. In one approach, Rasch measurement modeling can be used to create a standard, empirical measurement technique for determining a predictive model by creating the activation scale values, namely a continuous equal interval measure. Output values are equal interval and continuous, e.g., cost of health care for a patient in dollars or other currency, ER visit units by the patient, and/or units of hospital use. Ordinary least squares (OLS) regression analysis can only be done with an equal interval measure, so by converting to the activation scale, inputs such as a self-report questionnaire (like the PAM® survey) can be processed to predict health outcomes.

Using an assessment of a person's self-management ability with their health to predict healthcare utilization and cost based upon a point score change in a measurement tool provides a number of novel advantages. The use of an equal-interval scale continuous variable allows for regression analysis to identify risk, determine if intervening would be worthwhile in terms of cost and utilization reduction, and understand how gains in self-management translate to changes in utilization and cost.

The assessment system includes a regression modeling system using activation scale values as inputs. The regression modeling system applies a regression analysis process to measure the impact of change in activation scale value on healthcare costs, utilization and other outcome measures. That information can then be used with individuals or a population or users to predict risk and to predict changes in outcomes given different changes in activation scale values. This predictive insight then allows support and education resources to be aligned accordingly. More generally, the regression modeling system uses the regression analysis process as applied to a dataset to determine marginal differences in measures of health care costs as the activation scale values change. For example, the activation scale might linearly range from 0 to 100 and the marginal difference might refer to the amount that reflects health care cost increases or decreases with a one-point increase or decrease in activation scale value. Instead of considering costs as the dependent variable, other outcomes, such as biometric values, might be the dependent values. This is useful data for health care planners to determine whether a cost decline for a one-point activation scale value increase is a worthwhile investment and to align resources accordingly, or to determine predicted changes in other dependent variables and take action accordingly.

An activation scale value might be one of those independent variables. An example of an activation scale value is the score derived from the PAM® survey, which is measured by a 100-point scale, for example purposes. In some example embodiments, other numerical or cardinal scoring methods are applicable.

The activation scale is an equal interval scale and represents is a continuous variable. An individual's activation scale value is an independent variable that can be changed by actions, that is, it is malleable. As an activation scale value increases, health costs and utilization decline and other outcome measures improve.

In a specific example, health care costs do vary linearly with activation scale value. In that case, the model that is used to model costs might be represented by the equation Y=a+bx, where Y is a cost/utilization metric, a and b are the intercept and unstandardized regression coefficient, respectively, as determined by a regression analysis process, and x is an independent variable corresponding to the activation scale value.

The equation, or similar equations, can quantify a change in the activation scale value and its relationship to change in the dependent variable(s) such as cost and utilization, or biometrics. The algorithm may be configured to determine if intervening would be beneficial in terms of cost and utilization reduction, and how gains in self-management translate to changes in utilization and cost, such as by assessing the cost of an intervention, or effectiveness of an intervention, based upon activation scale value change.

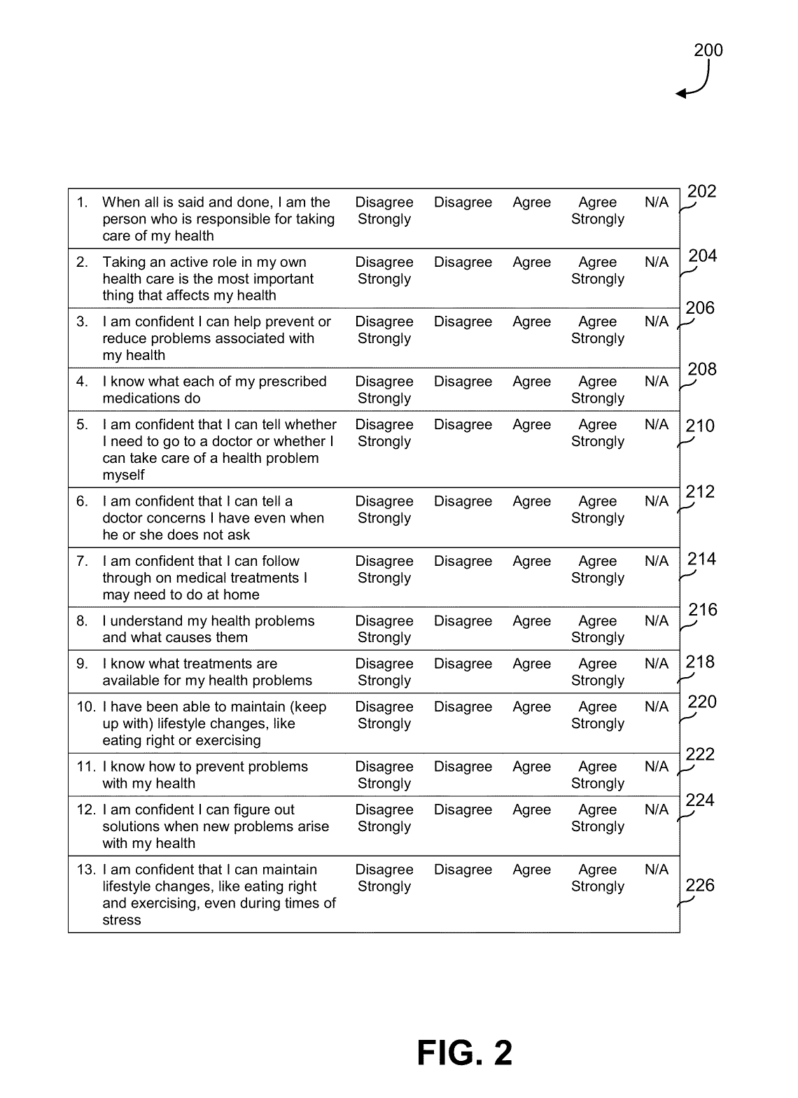

Regression analysis (described in more detail below in connection with FIG. 2) can show, as part of an equation/algorithm directed toward predictive risk and quantifying value, a user (patient or healthcare provider) how much a dependent variable changes (increases or decreases) for every unit of increase in the independent variable. For example, analysis might show that, for every one-point increase in a measured ability of a person to manage their own health, their annual medical costs might vary by a predicted amount.

FIG. 2 is an illustrative example of a survey 200 comprising a series of declarative statements to measure patient activation. The inventions described herein are not limited to this specific example of a survey and other surveys with similar functionality might be used instead. Example embodiments of an activation measurement survey assess the underlying knowledge, skills and confidence integral to managing one's own health and healthcare. With the ability to measure activation or a person's self-management ability, care support and education can be more effectively targeted and tailored to help individuals become more engaged and successful managers of their health.

For example, a survey may include a number of questions in the form of declarative statements, such as 10 or 13 declarative statements. The survey 200 includes 13 declarative statements and provides a user with five written options for responding to each question: disagree strongly, disagree, agree, agree strongly, or not applicable.

The first question states: When all is said and done, I am the person who is responsible for taking care of my health (202).

The second question states: Taking an active role in my own health care is the most important thing that affects my health (204).

The third question states: I am confident I can help prevent or reduce problems associated with my health (206).

The fourth question states: I know what each of my prescribed medications do (208)

The fifth question states: I am confident that I can tell whether I need to go to the doctor or whether I can take care of a health problem myself (210).

The sixth question states: I am confident that I can tell a doctor concerns I have even when he or she does not ask (212).

The seventh question states: I am confident that I can follow through on medical treatments I may need to do at home (214).

The eighth question states: I understand my health problems and what causes them (216).

The ninth question states: I know what treatments are available for my health problems (218).

The tenth question states: I have been able to maintain (keep up with) lifestyle changes, like eating right or exercising (220).

The eleventh question states: I know how to prevent problems with my health (222).

The twelfth question states: I am confident I can figure out solutions when new problems arise with my health (224).

The thirteenth question states: I am confident that I can maintain lifestyle changes, like eating right and exercising, even during times of stress (226).

In other variations, the questions might be asked differently. The assessment system (that includes a regression modeling system using activation scale values as inputs) might use the responses to these declarative statements as inputs that are transformed into an empirically derived interval level scale, namely the activation scale. The assessment system might change the ordinal responses to the declarative statements into cardinal (numerical) responses. The responses to the declarative statements may first be given a simple ordinal score, such as 0-4. The ordinal responses may be transformed into a numerical score that is along an equal-interval scale in order to use the numerical score as a variable in a regression analysis. The regression analysis may then be used to develop the predictive model.

The results of the activation measurement survey for a single person, such as a single patient, once processed according to examples herein, can be used as an activation scale value for that patient. The processed survey results across a series of patients or multiple users provide for an activation measurement baseline for a population that can be tracked over time or even compared on a mean basis between population segments, including comparing activation level segments.

The regression model requires both independent and dependent variables (as described in connection with FIG. 1 above) that are equal-interval scale continuous variables such that the independent variable that impacts/affects cost can be changed in order to reduce the cost of healthcare. Example embodiments provide for a method of showing that a single point increase in an activation scale value is related to a sizeable (e.g., meaningful) decline in healthcare utilization and costs. The method of applying a regression analysis to examine how much healthcare costs increase and decrease can be based on a single point change in activation scale value or percentage of activation scale value change.

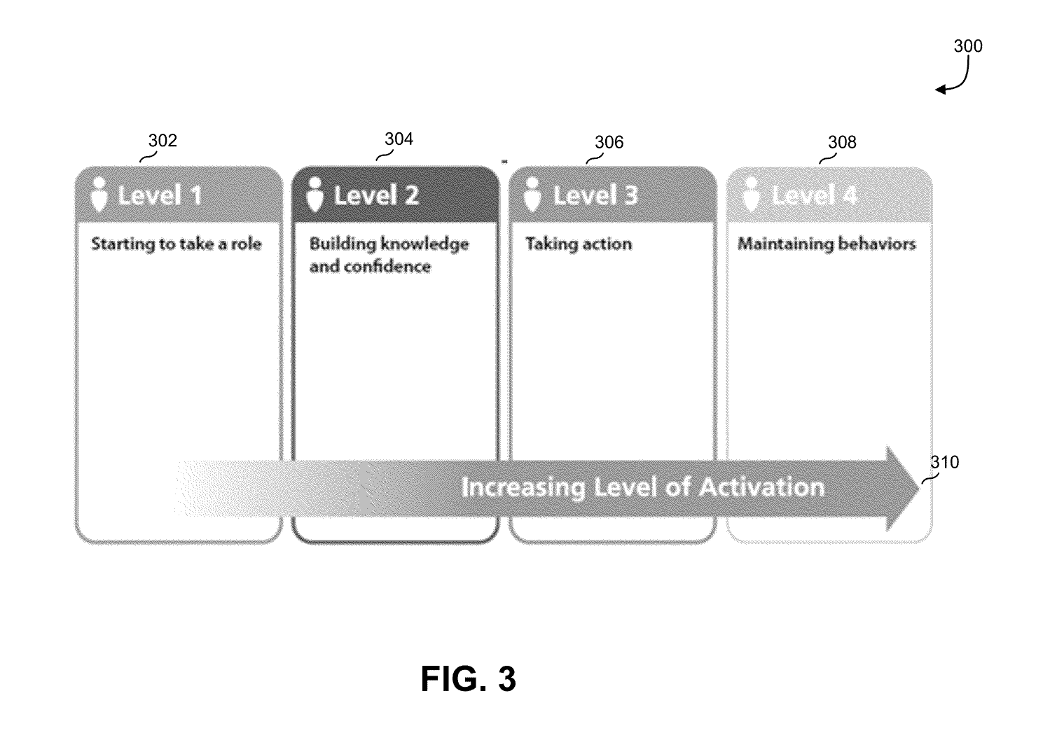

FIG. 3 is an illustrative example of a block diagram 300 showing different levels of activation scale values for measuring the level of a user in accordance with example embodiments. As will be appreciated, although four levels are used for purposes of explanation, different numbers and levels may be used, as appropriate, to implement various embodiments.

An activation assessment might segment consumers into one of four activation levels along an empirically derived continuum. Each scale level is measured according to an increasing level of activation (310). For example, level 1 (302) starts with users (e.g., patients) starting to take a role; for example, patients do not yet grasp that they must play an active role in their own health. They are disposed to being passive recipients of care. Level 2 (304) includes building knowledge and confidence; for example, patients may still lack the basic health-related facts or have not connected these facts into larger understanding of their health or recommended health regiment. Level 3 (306) involves taking action; for example, patients have the key facts and are beginning to take action but may lack the confidence and skill to support their behaviors on a consistent basis. Level 4 (308) involves maintaining behaviors; for example, patients have adopted new behaviors but may not be able to maintain them in the face of stress, change or health crises.

Each level provides insight into an array of health-related characteristics, including attitudes, motivators, behaviors, and outcomes. Over 200 health-related characteristics, such as attitudes, behaviors, and outcomes, have been mapped to a PAM® survey assessment score and level of activation, offering a wealth of insight into an individual's self-management competencies.

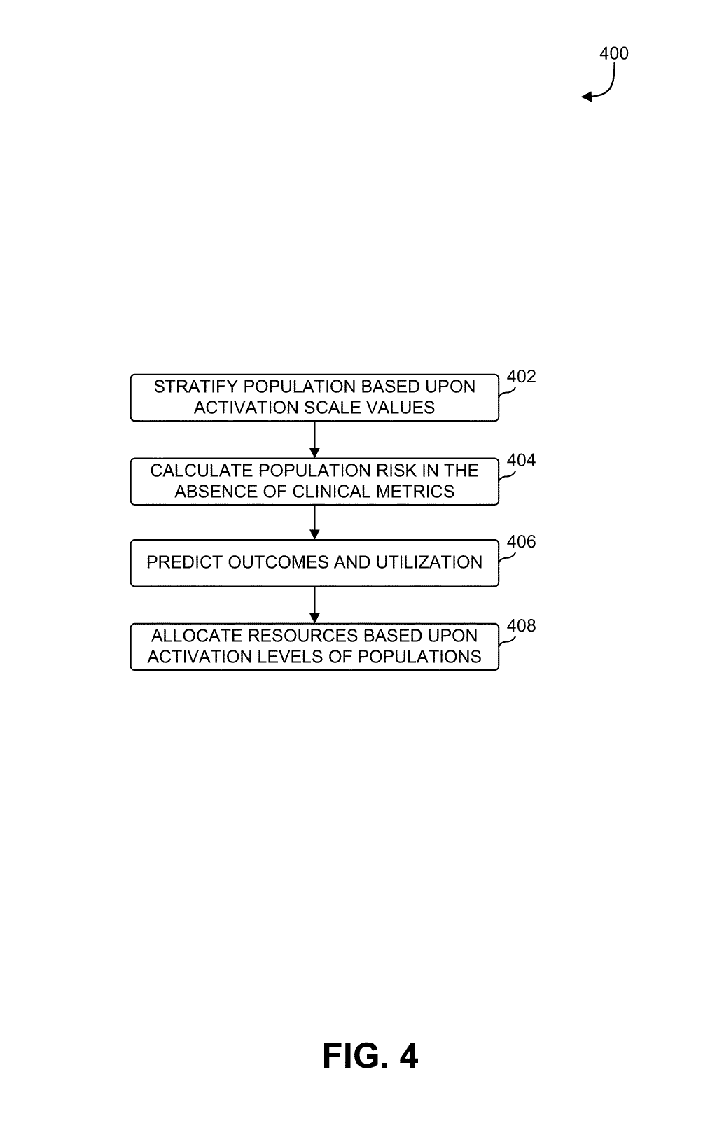

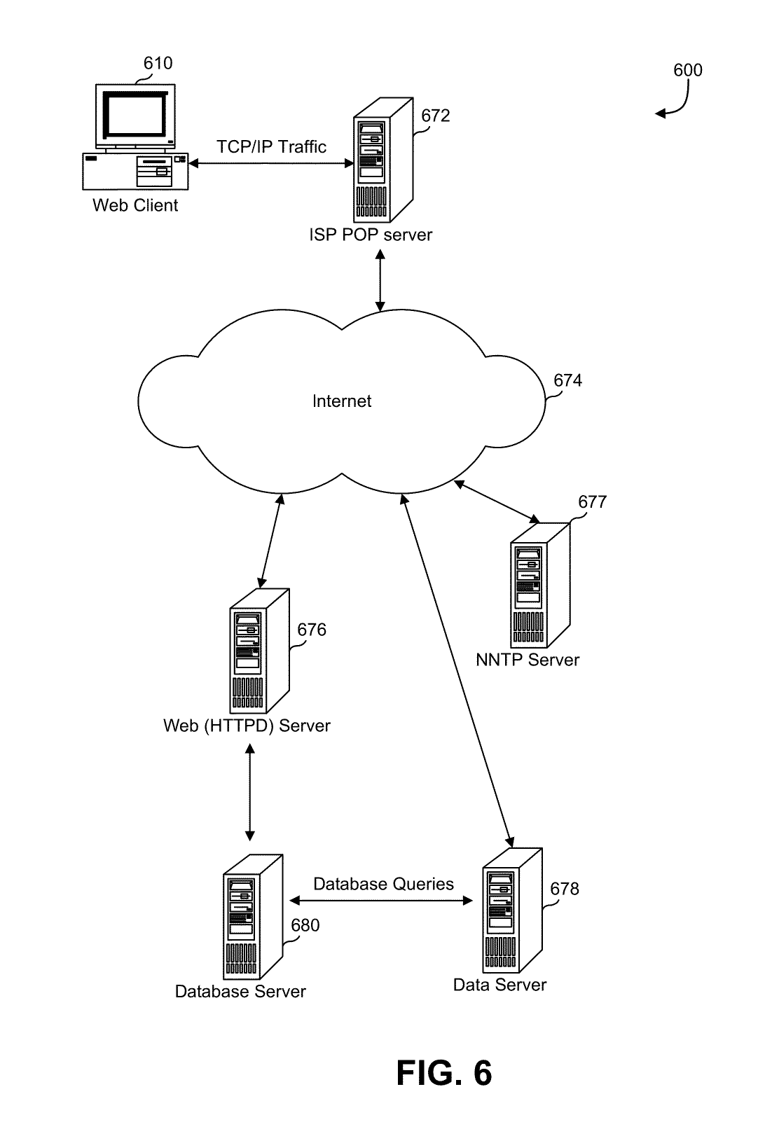

FIG. 4 is an illustrative example of a process 400 for creating health management measurements in connection with example embodiments. A host computer system, such as the host computer system described and depicted in connection with FIG. 6, may perform at least a portion of the process illustrated in FIG. 6. Other entities operating with a computer system environment may also perform at least a portion of the process illustrated in FIG. 4 including, but not limited to, services, applications, modules, processes, operating system elements, virtual machine elements, network hardware, or combinations of these and/or other such entities operating within the computer system environment.

The host computer system may stratify populations into activation levels based at least in part upon activation scale values (402), calculate population risk in the absence of clinical metrics (404), predict outcomes and utilizations based at least in part on the activation scale values (406), and allocate resources based upon activation levels of populations (408).

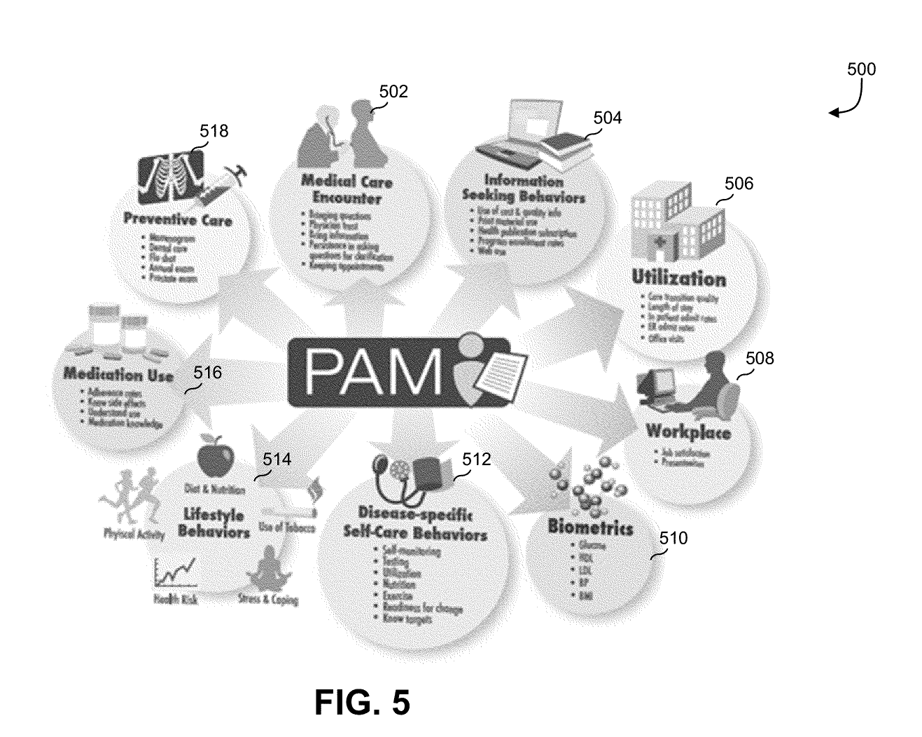

FIG. 5 is an illustrative example of a block diagram 500 showing variables that could be used for controlling costs and achieving health care quality improvements requiring the participation of activated and informed consumers and patients. The block diagram 500 displays different categories that are considered as examples of healthcare subjects and attributes that may be considered during the utilization/cost analysis and for other predictive assessment measurements.

For example, the medical care encounter (502) includes attributes such as bringing questions, physician trust, bringing information, persistence in asking questions for clarification, or keeping appointments.

Another instance of attributes associated with healthcare management activation measurement includes: information-seeking behaviors (504), which may include the use of cost and quality information, print material use, health publication subscriptions, program enrollment rates, and Web use.

Another consideration would be equal-interval scale continuous variables including utilization (506), which can include length of stay, in-patient admittance rates, ER admittance rates, and office visits.

Another subject relevant to the healthcare management activation measurement system may include workplace (508) information, such as job satisfaction.

Another subject may be biometrics, which are equal-interval scale continuous variables (510), which may include tests and results such as glucose, HDL, LDL, BP, and BMI. Disease-specific self-care behaviors (512) may also be used, such as self-monitoring, testing, utilization, nutrition, exercise, readiness for change, or knowing targets.

Another instance of attributes associated with healthcare management activation measurement includes lifestyle behaviors (514), which may include diet and nutrition, use of tobacco, stress and coping, health risk, or physical activity.

Another instance of attributes associated with healthcare management activation measurement includes medication use (516), such as knowing side effects, understanding use, medication knowledge, and the like. Another subject may be preventive care (518), such as getting a mammogram, dental care, flu shot, annual exam, prostate exam, and the like.

These subject matters can be used along with or included in survey-based predictive models for healthcare activation and manageability, or considered in making longitudinal studies that determine cost/utilization outcomes, or for other purposes for assessing healthcare management.

Alternative methods and systems according to the present disclosure further include a Web-based system for providing information and surveys to users. For example, at the lower levels of activation, the program focuses on building a base of knowledge, basic skills, and confidence. At higher activation levels, topics close knowledge gaps and support the development of more complex skills and new behaviors as individuals strive to achieve guideline behaviors.

In example embodiments of the Web-based system, the PAM® survey measurement (the activation measurement survey and score) is a first step into the process. For example, based upon a PAM® survey score and other methods of personalization, progress to the next level of curriculum is determined by an activation scale value re-measurement when administered by a coach, doctor, hospital, the individual, or triggered by an algorithm.

Low-activated individuals (levels 1 and 2) typically represent 30% to 40% of a commercial population (higher in Medicare and Medicaid), but account for a much greater percentage of healthcare utilization and costs. Engaging these individuals in their health is essential to improved health and control over healthcare spending. For example, where it is found that low-activated individuals and high-activated individuals are online at the same rates, low-activated individuals are much less likely than high-activated individuals to go online for health-related information and low-activated individuals might need healthcare approaches that are specific to them, such as the use of in-clinic support, phone support, etc.

In such alternative embodiments, coaching, such as telephone coaching and Web-based coaching, or improved patient experiences in clinics may provide assistance to individuals in the low-activated categories (e.g., levels 1 and 2) in order to help improve patient experience and help to raise the patient to a more highly-activated state (e.g., levels 3 or 4). In such example embodiments, the assistance, whether from the Web-based program, telephone-based system, or in-person system may act to improve the activation scale value of the patient. As noted above, even a one-point increase in activation scale values may substantially change the utilization or costs associated with the resources expended on the patient in short-term and/or long-term care.

FIG. 6 illustrates aspects of an example environment 600 for implementing aspects in accordance with various embodiments. As will be appreciated, although a Web-based environment is used for purposes of explanation, different environments may be used, as appropriate, to implement various embodiments. The environment includes an electronic client device, such as the Web client 610, which can include any appropriate device operable to send and/or receive requests, messages, or information over an appropriate network 674 and, in some embodiments, convey information back to a user of the device. Examples of such client devices include personal computers, cell phones, laptop computers, tablet computers, embedded computer systems, electronic book readers, and the like. In this example, the network includes the Internet, as the environment includes a Web server 676 for receiving requests and serving content in response thereto and at least one application server 677. It should be understood that there could be several application servers. Servers, as used herein, may be implemented in various ways, such as hardware devices or virtual computer systems. In some contexts, servers may refer to a programming module being executed on a computer system. The example further illustrate a database server 680 in communication with a data server 678, which may include or accept and respond to database queries.

Further embodiments can be envisioned to one of ordinary skill in the art after reading this disclosure. In other embodiments, combinations or sub-combinations of the above-disclosed invention can be advantageously made. The example arrangements of components are shown for purposes of illustration and it should be understood that combinations, additions, re-arrangements, and the like are contemplated in alternative embodiments of the present invention. Thus, while the invention has been described with respect to exemplary embodiments, one skilled in the art will recognize that numerous modifications are possible.

For example, the processes described herein may be implemented using hardware components, software components, and/or any combination thereof. The specification and drawings are, accordingly, to be regarded in an illustrative rather than a restrictive sense. It will, however, be evident that various modifications and changes may be made thereunto without departing from the broader spirit and scope of the invention as set forth in the claims and that the invention is intended to cover all modifications and equivalents within the scope of the following claims.

It should be understood that elements of the block and flow diagrams described herein may be implemented in software, hardware, firmware, or other similar implementation determined in the future. In addition, the elements of the block and flow diagrams described herein may be combined or divided in any manner in software, hardware, or firmware. If implemented in software, the software may be written in any language that can support the example embodiments disclosed herein. The software may be stored in any form of computer readable medium, such as random access memory (“RAM”), read only memory

(“ROM”), compact disk read only memory (“CD-ROM”), and so forth. In operation, a general purpose or application-specific processor loads and executes software in a manner well understood in the art. It should be understood further that the block and flow diagrams may include more or fewer elements, be arranged or oriented differently, or be represented differently. It should be understood that implementation may dictate the block, flow, and/or network diagrams and the number of block and flow diagrams illustrating the execution of embodiments of the invention.

The foregoing examples illustrate certain example embodiments of the invention from which other embodiments, variations, and modifications will be apparent to those skilled in the art. The invention should therefore not be limited to the particular embodiments discussed above, but rather is defined by the claims.

While this invention has been particularly shown and described with references to example embodiments thereof, it will be understood by those skilled in the art that various changes in form and details may be made therein without departing from the scope of the invention encompassed by the appended claims.

Various embodiments of the present disclosure utilize at least one network that would be familiar to those skilled in the art for supporting communications using any of a variety of commercially-available protocols, such as Transmission Control Protocol/Internet Protocol (“TCP/IP”), protocols operating in various layers of the Open System Interconnection (“OSI”) model, File Transfer Protocol (“FTP”), Universal Plug and Play (“UpnP”), Network File System (“NFS”), Common Internet File System (“CIFS”), AppleTalk, or others. The network can, for example, be a local area network, a wide-area network, a virtual private network, the Internet, an intranet, an extranet, a public switched telephone network, an infrared network, a wireless network, a peer-to-peer (p2p) network or system, an ad hoc network, and any combination thereof

In embodiments utilizing a Web server, the Web server can run any of a variety of server or mid-tier applications, including Hypertext Transfer Protocol (“HTTP”) servers, FTP servers, Common Gateway Interface (“CGP”) servers, data servers, Java servers and business application servers. The server(s) also may be capable of executing programs or scripts in response to requests from user devices, such as by executing one or more Web applications that may be implemented as one or more scripts or programs written in any programming language, such as Java®, C, C# or C++, or any scripting language, such as Perl, Python or TCL, as well as combinations thereof. The server(s) may also include database servers, including, without limitation, those commercially available from Oracle®, Microsoft®, Sybase® and IBM®.

Alternative embodiments can be based on a peer-to-peer information storage and exchange system rather than storage and communication protocols in a client-server system.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., may be either A or B or C, or any nonempty subset of the set of A and B and C. For instance, in the illustrative example of a set having three members used in the above conjunctive phrase, “at least one of A, B, and C” and “at least one of A, B and C” refers to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C to each be present.

Operations of processes described herein can be performed in any suitable order unless otherwise indicated herein or otherwise clearly contradicted by context. Processes described herein (or variations and/or combinations thereof) may be performed under the control of one or more computational systems configured with executable instructions and may be implemented as code (e.g., executable instructions, one or more computer programs or one or more applications) executing collectively on one or more processors, by hardware or combinations thereof The code may be stored on a computer-readable storage medium, for example, in the form of a computer program comprising a plurality of instructions executable by one or more processors. The computer-readable storage medium may be non-transitory.

The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

All references, including publications, patent applications, and patents, cited herein are hereby incorporated by reference to the same extent as if each reference were individually and specifically indicated to be incorporated by reference and were set forth in its entirety herein.

What is claimed is:

1. A computer-implemented method for modeling, using a computer system, to predict healthcare utilization and cost based upon a person's activation scale value, wherein the activation scale value is a variable representing, as a number, a user's patient activation and/or self-management ability in making health decisions, the method comprising:
obtaining activation scale values over a plurality of survey participants;
generating a regression to identify a predictive model that can have a direct explanatory relationship to dependent variables, including healthcare utilization and cost, wherein the predictive model models changes in the dependent variables as a result of changes in the activation scale values, wherein the dependent variables and the activation scale values are equal-interval scale continuous variables; and
outputting results.

2. The computer-implemented method of claim 1, wherein the activation scale is an empirically-derived, linear, equal interval scale.

3. The computer-implemented method of claim 1, wherein the activation scale values are based at least in part on independent and dependent variables, wherein the independent and dependent variables are equal-interval scale continuous variables.

4. The computer-implemented method of claim 1, wherein the activation scale values are determined based on a survey of a user's level of agreement with declarative statements, the declarative statements including:
(a) I am the person who is responsible for taking care of my health;
(b) Taking an active role in my own health care is the most important thing that affects my health;
(c) I am confident I can help prevent or reduce problems associated with my health;
(d) I know what each of my prescribed medications do;
(e) I am confident that I can tell whether I need to go to a doctor or whether I can take care of a health problem myself;
(f) I am confident that I can tell a doctor concerns I have even when he or she does not ask;
(g) I am confident that I can follow through on medical treatments I may need to do at home;
(h) I understand my health problems and what causes them;
(i) I know what treatments are available for my health problems;
(j) I have been able to maintain (keep up with) lifestyle changes, like eating right or exercising;
(k) I know how to prevent problems with my health;
(l) I am confident I can figure out solutions when new problems arise with my health; and
(m) I am confident that I can maintain lifestyle changes, like eating right and exercising, even during times of stress.

5. A computer-implemented method for modeling, using a computer system, to predict healthcare utilization and cost based upon a user activation scale, wherein an activation scale value is a variable representing, as a number, a user's patient activation, self-management ability, and/or engagement in one's own health and healthcare, the method comprising:
providing a survey of self-management declarative statements to a set of users, to each user of the set of users;
mapping the results of the survey from ordinal responses to an empirically-derived, linear, equal interval scale to form activation scale values;
performing a regression model, employing Rasch measurement modeling, on the activation scale values;
outputting results of the regression model based at least in part on the results; and
using, at least in part, the results to predict healthcare utilization and cost outcomes for each user, of the set of users.

6. A non-transitory computer-readable storage medium having stored thereon executable instructions that, when executed by one or more processors of a computer system, cause the computer system to at least:
provide a survey of self-management declarative statements to a population of users, each user of the population of users providing ordinal survey responses to survey declarative statements;
map survey responses from ordinal responses to an empirically-derived, linear, equal interval scale to form activation scale values;
perform a regression analysis using Rasch measurement modeling on the activation scale values;
output results of the regression analysis; and
use, at least in part, the results to predict healthcare utilization and cost outcomes for each user of the population of users.

7. The non-transitory computer-readable storage medium of claim 6 wherein the survey responses, once rendered, provide activation scale values that are determined based on the survey.
